(19) United States
(12) Patent Application Publication
(10) Pub. No.: US 2012/0254734 A1
(43) Pub. Date: Oct. 4, 2012

(54) GRAPHICS-PLUGIN AND SERVER METHOD FOR INVITATION DESIGNS

(76) Inventor: Renae C. Judkins, North Las Vegas, NV (US)

(21) Appl. No.: 13/078,988

(22) Filed: Apr. 3, 2011

(51) Int. Cl. G06F 17/24

(52) U.S. Cl. 715/243

(57) ABSTRACT

A computerized, web-based, method and system for improved (high-end) stationary designs for invitations to weddings and other important events. The method and system is based on two software components. One component is a plug-in for a graphics program, often a high end graphics program such as Adobe Photoshop, Adobe Illustrator, and Adobe Indesign. This plug-in allows the graphics program to communicate with the second component of the system, which is a remote Internet web server loaded with a variety of different invitation templates. Using this system, the user can, while working within the familiar user interface of a stand-alone graphics program, import templates for custom paper product designs, and rapidly produce highly realistic images for client evaluation. These methods are also highly suitable for allowing users to communicate interest in new designs, as well as directly ordering materials from the manufacturer from within the same graphics program.

### BACKGROUND OF THE INVENTION

1. Field of the Invention

This invention is in the field of graphics design software and Internet communications as it relates to the design process for high-end custom wedding and party invitations, and other custom paper products.

2. Description of the Related Art

Invitations, in particular formal invitations such as invitations to parties, weddings, baby showers, birthdays and the like are often highly complex paper products composed of multiple pieces of unusually sized, cut, colored, and folded pieces of paper or other material. For example, a wedding invitation may consist of a complex tri-fold product with interior pockets to hold several smaller custom sized cards, often with complex graphics, and this assembly in turn may fit into one or more outer envelopes. Thus invitation assemblies composed of 5 or even 10 or more separately cut pieces are common.

As a result, a huge number of different types of invitations are possible. The practical intent of the industry is to offer so many permutations or combinations that the chance of any two invitations being made from the same identical base components is very slight. That is, the unstated goal is to make every invitation effectively unique. This satisfies the customer's desire to send out something that looks (and indeed is) expensive and special, and at the same time acts to turn what otherwise might be a commodity product (cut paper) into a relatively expensive custom product.

As an example, consider the huge number of different paper invitation products offered by one popular manufacturer, Options Inc., of Whippany, N.J., who promotes their products on the website: “doitwithmoreoptions.com”.

Doitwithmoreoptions offers invitations in a variety of different shapes, such as pocket invitations, add-on pocket invitations, enveloper invitations, pouchette invitations, jacket invitations, gatefold invitations, tag invitations, index invitations, and E-Z invitations.

Some of the various envelopes include envelopes such as 4-bar envelopes, A2 envelopes, A6 envelopes, A7 envelopes, A8 envelopes, A9 envelopes, No. 10 envelopes, outer envelope #7, square envelopes, top open envelopes, tea envelopes, string tie envelopes, 6×9 envelopes, no bend envelopes, cellophane bags, and envelope liners.

The company also sells various cards, including rectangular cards, square cards, rectangular paper, and square paper cards, as well as fold-over cards such as landscape cards, tent cards, Z-fold cards, and U-fold cards.

The complexity becomes further magnified because these basic shapes in turn may be made from various types of paper, such as classic crest paper, classic linen paper, felt wave paper, gala collection paper, metallic collection paper, translucent paper, and pattern type paper.

The paper itself can further come in various colors such as solar white, natural white, baronial ivory, Havilland blue, sunshine, and black; or cream, ivory, lemon, salmon, pink, blush, coral, raspberry, lavender, citrus green, tropical green, kiwi, milkweed, desert storm, celadon, aqua, baby blue, blue flower, lake, pumpkin, red, chocolate, peace, wealth, and Nero.

The paper may also come pre-printed with various patterns, such as paisley text, venezia text, Florence text, petula text, swirling dot text, starlight text, damask text, and chrysanthemum text.

In addition to more traditional papers, metallic papers are also available which can come in various colors such as stardream snow, stardream quartz, stardream opal, metallic beige, metallic butter, stardream peach, stardream rose, stardream azalea, stardream Jupiter, stardream mars, stardream punch, stardream rubu, stardream alpine, stardream lilac, stardream bluebell, stardream vista, stardream iris blue, stardream aquamarine, stardream lagoon, stardream serpentine, stardream lime, stardream fairway, stardream gold leaf, stardream gold, stardream amber, metallic cappuccino, stardream antique gold, stardream bronze, stardream copper, stardream flame, stardream luster, stardream silver, stardream onyx, stardream pewter.

The paper may come in various thicknesses (weight) as well, such as 24 lb, 32 lb, and 38 lb. The net result is potentially hundreds of thousands or more of different permutations.

To produce these custom invitations, customers often turn to professional designers. At present, these designers usually order samples of the various invitation designs from manufacturers such as Envelopments Inc., Santa Ana, Calif., or Options Inc., Whippany, N.J., or other manufacturers. Each manufacturer often has its own unique set of paper products, and in part for competitive advantage, each manufacturer is often reluctant to share the exact details (e.g. exact dimensions) of its various products. Instead designers often must order samples from the various manufacturers by mail, show them to their customers, and then order still more material, which is a slow process that can often take up to six weeks or more.

An additional and likely intentional aspect of the present system is that it helps create a formidable barrier to entry for new manufacturers into the field. Thus although the actual mechanical difficulty of producing a new invitation design and/or material is not particularly high, a new manufacturer entering the field must compete with established competitors who may be offering hundreds of thousands of different products. Since the customers of such custom invitations often desire access to new and unusual designs, the present system acts to thwart customer desires in this regard.

Further, although the customers of such custom invitations often wish to employ costly signaling to show, by the use of expensive custom invitations, that their particular event is unusually important, the customers are usually not so happy with the long delays that are presently a part of the process. Due to these delays, it may take many weeks before a customer can even adequately preview their design. As a result, customers may be forced to use combinations that they may not be fully happy with, simply because there is not enough time left to try another combination.

To help address this problem, certain dedicated computer graphics programs designed for invitation design are available. For example, MountainCow LLC, Providence, R.I., produces a software program called “Invitation Architect”.

This program is oriented specifically for invitation design by unskilled users, and includes some templates for invitation products produced by companies such as Envelopments, AccuCut, and Carlson Craft. Although the user interface for this software is relatively simple, in order to achieve this simplicity, the software lacks flexibility and realism. Thus instead of producing photorealistic images of a complex invitation, the software instead produces one-at-a-time, untextured, cartoon-like images of the individual invitation components. Further, the program is closed in that new manufacturers cannot easily provide their new designs and templates. Thus further improvements in this field would be desirable.

### BRIEF SUMMARY OF THE INVENTION

The invention is based, in part, upon the insight that professional designers generally prefer the greater artistic control and realism provided by high-end general purpose graphics programs, exemplified by programs such as Adobe Photoshop, Adobe Illustrator, and Adobe Indesign. Such high-end programs, if fed the proper invitation template data, would enable designers to rapidly produce highly realistic, or even photorealistic, preview images of various invitations for their customers on an almost real-time basis.

Further, since customers often produce complex invitation designs involving many (e.g. often around 5-10 or more) individual paper components, such customers often wish to view a photorealistic image of the entire invitation package of paper components as a unified whole before ordering. Thus ideally the invention should provide this ability as well.

The invention is also based, in part, upon the insight that a more open system that would allow an unlimited number of manufacturers to compete on an equal basis would be beneficial to customers. That is, if a method could be found to reduce the barrier to entry to the field, many more unusual and creative invitations and other paper products could be made available to customers who tend to desire new and unique products.

The invention is also based in part, on the insight that high end general purpose graphics programs, again exemplified by programs such as Adobe Photoshop, Adobe Illustrator, and Adobe Indesign, can have their functionality extended though the use of plug-ins.

The Invention is also based, in part, on the further insight that an Internet based server system, particularly if designed to allow new manufacturers to enter in the template designs for their new paper products, would be an ideal forum for template exchange.

This, in one embodiment of the invention, the invention may be a method and system to provide an improved computerized invitation design and previews. This method and system will generally consist of at least two components. One component will be a plug-in for a graphics program, often a high end graphics program (e.g. Adobe Photoshop, Adobe Illustrator, and Adobe Indesign). This plug-in allows the graphics program to communicate with the second component of the system, which is a remote Internet web server, and import templates for custom paper product designs, all while working within the familiar (to professional designers) user interface of the high-end graphics program.

More specifically, in one embodiment, the invention may be a method of creating custom paper designs using a plug-in capable, stand-alone graphics program, such as Adobe Photoshop, Adobe Illustrator, or Adobe Indesign that is running on an Internet connected computerized device, such as a desktop computer, laptop computer, tablet or even a Smartphone. The method will generally comprise storing a plurality of graphics templates for custom paper designs on a remote Internet server. The templates may be in any number of digital graphics formats, such as *.PSD, *.PDD, .BMP, .TIF, .GIF, .EPS, .JPG, .PCS, .PDF, .PNG, .DXF and so on. Often these paper design templates will be annotated with metadata or linked to metadata that can provide additional information on a per-template basis, such as the name of the template, a thumbnail graphic of the template contents, the identity of the manufacturer or distributor that supplies the product illustrated on the template, and possibly much more as well such as links to the manufacturer or distributor of the product, pricing and availability information, back-back order status, and so on.

According to this embodiment of the invention, the invention will operate by way of a plug-in that may be installed in the stand-alone graphics program. This plug-in is designed so that the user of the graphics program (i.e. the designer) can, while working within the user interface of this graphics program, establish communication with a remote Internet server that stores various templates of interest. The user, working within this graphics program, may activate the plug-in, contact the remote server over the Internet, and retrieve template metadata from the remote Internet server (or template server). The user may view at least some of this template metadata (e.g. such as the name, manufacturer, and/or thumbnail image) of the template, select a template of interest, import the template into the graphics program, and then use the imported template to create a highly realistic custom invitation or other paper design. This design may then be given to the designer's customer for rapid review.

In alternative embodiments, the graphics program plug-in and server system can also be used to facilitate communication between the manufacturer and designer. Thus a manufacturer can communicate the status (e.g. in-stock, out-of-stock, backorder time, anticipated delivery time) of various paper products, as well as other information such as price, via template metadata that is also stored on or transmitted by the server. The designer can in turn communicate interest in various proposed new designs or back-ordered or out of stock designs, as well as place orders for various designs, again conveniently working from within the interface of the high-end graphics program, and again by way of template metadata that is stored and/or transmitted by the server.

### BRIEF DESCRIPTION OF THE DRAWINGS

FIG. 1 shows an example of a typical invitation card product composed of five different paper products, including a custom printed paper tri-fold, two custom printed paper cards, a custom printed paper envelope, and a custom printed paper envelope sash. Here the invitation is shown both with and without a textured background.

FIG. 2 shows an example of how the invention's graphics program plug-in and template exchange server system can allow a plurality of users and paper product manufacturers to communicate and exchange templates.

FIG. 3 shows a more detailed view of some of the major software modules of the invention's graphics program plug-in.

FIG. 4 shows an example of how the invention's graphics program plug-in can create a user interface, from within the graphics program, that allows the user to connect to the invention's template exchange server.

FIG. 5 shows an example of how the invention's graphics program plug-in can create a user interface, from within the graphics program, that allows the user to browse through a variety of different templates from different manufacturers and select an appropriate template for evaluation and possible customization with the customer's specific text and/or graphics.

FIG. 6 shows an example of how the template selected from the remote graphics exchange server in FIG. 5 can then be imported into the graphics program.

FIG. 7 shows an example of an additional e-commerce application, where the user can inquire about price and/or availability of a paper product or products that correspond to a particular template of interest, and either register interest in the template and/or order the corresponding paper product from the manufacturer or distributor.

### DETAILED DESCRIPTION OF THE INVENTION

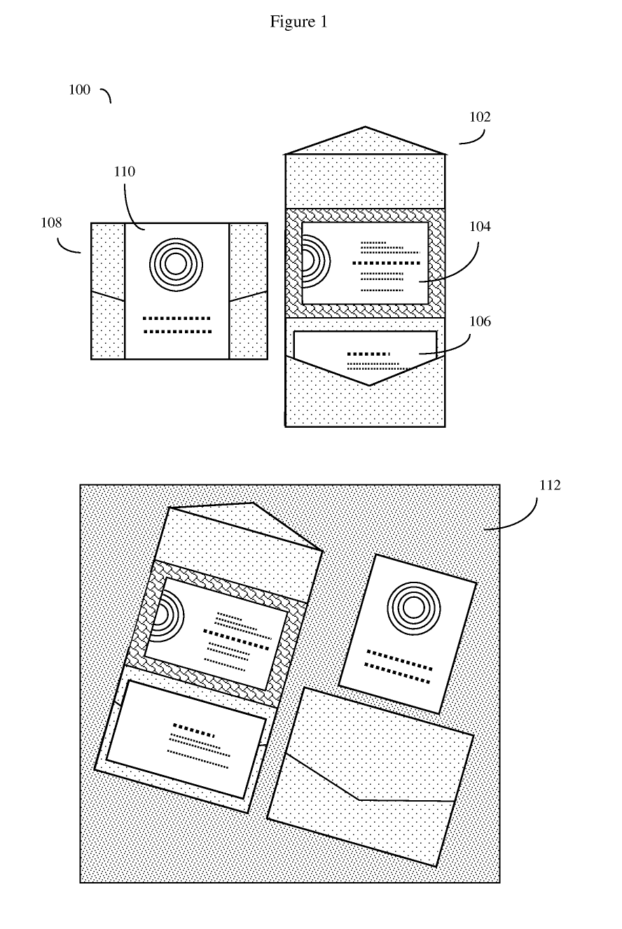

In order to better appreciate the context of the invention, consider an example of a relatively simple high-end custom paper invitation, such as might typically be done for a few important life occasions, such as weddings, baby showers, or important parties. Such an invitation is shown in FIG. 1.

FIG. 1 shows an example of a typical invitation card product (100), and also a graphics template for this product, which is composed of five different paper components, including a custom printed paper tri-fold (102), two custom printed paper cards (104) (106), a custom printed paper envelope (108), and a custom printed paper envelope sash (110). Here the template may show the invitation both with and without a textured background (112), or at least provide a textured background for the designer to manipulate. The textured background (112, which might for example be a table cloth linen background, can be important because it helps both the client and customer evaluate the proposed invitation design in a natural setting that approximates the setting in which the receiver of the invitation may read it.

For such occasions, the customer will often deliberately choose an invitation format that is both non-standard and expensive to produce. This type of communication is known as “costly signaling”; because the mere act of sending an expensive and custom invitation of this type is difficult to counterfeit. Rather, the expensive invitation communicates to the recipient that this expensive custom invitation is genuinely intended to represent an important occasion.

However costly signaling need not be slow and inefficient signaling. Further, costly signaling in this context is even more effective if the universe of possible unique invitations is very large, and here the invention facilitates the customer's goals by, as will be discussed, by allowing a large number of different manufacturers to provide templates for unusual custom products. For example, using the invention, a very high end but low-volume manufacturer might provide uncommonly used templates (e.g. gold leaf embossed papers) for very expensive invitations made from unusually expensive or rare materials.

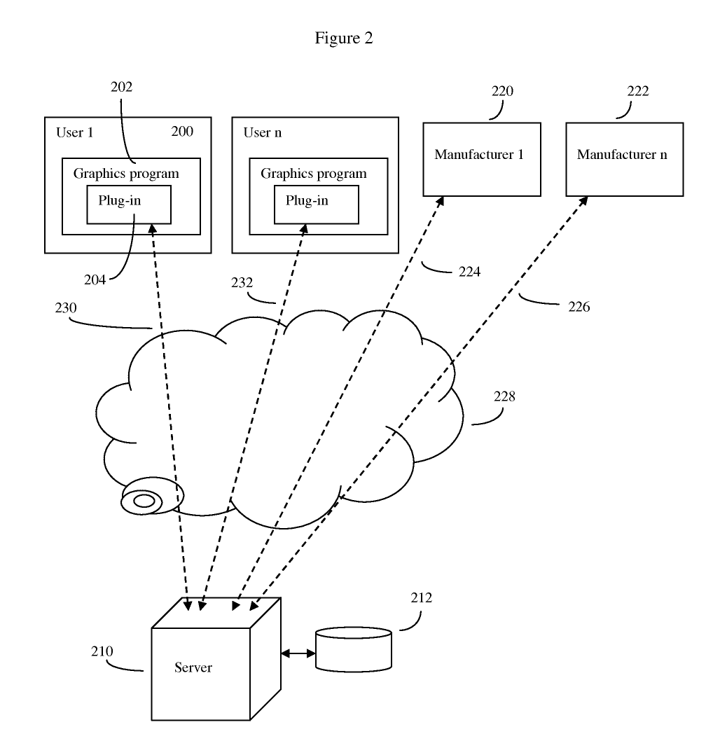

FIG. 2 shows an example of how the invention's graphics program plug-in and template exchange server system can allow a plurality of users and paper product manufacturers to communicate and exchange templates for a wide variety of invitation components.

Here users, running network connected computerized devices (200) such as desktop computers, laptop computers, tablets, or even Smartphones will generally run plug-in capable, stand alone (capable of running within the computerized device even in the absence of network connectivity) graphics programs (202), usually on top of an operating system such as Windows, Linux, iOS, Android, and the like (306). The computerized devices will generally consist of at least one processor (often an x86, ARM, or MIPS family processor), memory, a network connection to the Internet, and a graphical user interface running on a display screen with a keyboard and mouse, touch screen, or other interface method. The invention's plug-in, which as previously discussed works by interacting with the graphics program API, is shown as (204). The invention's components and methods are thus implemented in the form software that resides in part in the memory of the computerized device (200).

The other part of the invention is implemented in the form of software components and methods stored in the memory of remote Internet template server (or simply server) (210). Server (210) will often itself be comprised of at least one processor, memory, network connection, and web server software such as an operating system (often Linux) and associated Internet stack software, such as the popular open source software LAMP solution stack (bundle) (Linux, Apache, MySQL, Perl/PHP/Python or other software). Alternatively proprietary Internet web software such as Microsoft Windows, Mac OS, Solaris, or OpenBSD may also be used. The methods of the invention will often be implemented, in part, in the form of various software scripts and applications running in this environment.

Generally the server (210) will operate a database of various templates (212) and template metadata via database software such as MySQL and the like.

In use, various manufacturers (220), (222) of suitable invitation paper products (or distributors of these products, or the system administrators—here for simplicity, the term manufacturer and distributor will be used interchangeably, and the system administrator will often be lumped in with the manufacturer as well) will load templates and metadata corresponding to their particular product on to the database (212) via server (210) and appropriate Internet network connections (224), (226). Here the Internet itself is symbolized by the cloud (228). To facilitate this process, the server (210) will often be configured to provide various manufacturer or system administrator interfaces to upload and manage these templates. Such interfaces can be as simple as common FTP interfaces, or they may be more sophisticated web based interfaces, as desired.

In the various examples discussed, here, assume that the database (212) has been previously loaded with various templates. Here various users are using the plug-in (204) in their graphics programs (202) to communicate with the server (220) and database (222) over Internet connections such as (230) and (232).

Alternatively, the templates may be uploaded by users or system administrators, rather than manufacturers. For example, at least initially, users and system administrators may stock the template database with templates created from photographs or samples of various designs. These templates may, for example, be created one by one, and then changed to each color, size and pattern as appropriate. The templates may further be transformed to different angles (e.g. the angles shown with background (112)). The templates may also be transformed to the configurations such as closed and separate pieces, and then changed to each color, size and pattern again. As new products are introduced to the stationary industry, the database (212) can then be refreshed with new templates.

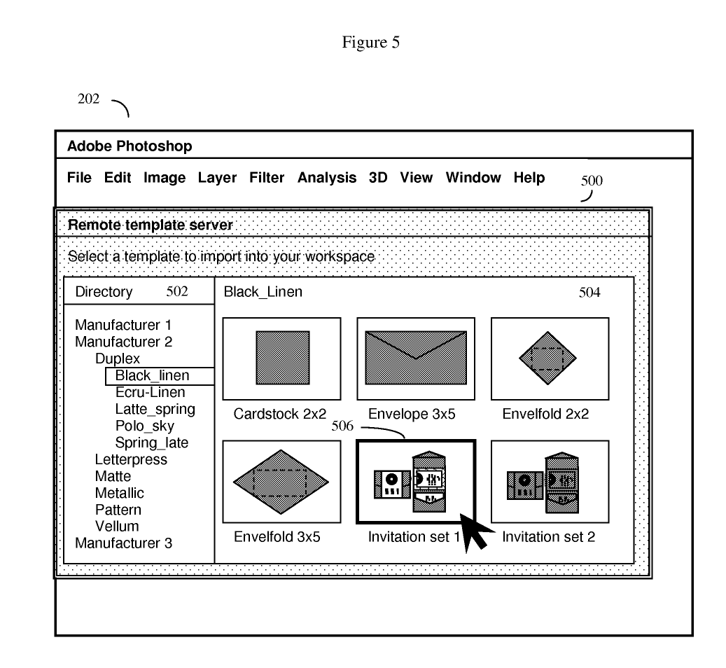

In operation, the database (212) may, for example have over 100,000 invitation templates available in every shape and color. As will be shown in FIG. 5, an invitation designer can use the graphics program and plug-in to search or browse these various template designs by various methods (e.g. by manufacturer and manufacturer folder category) and pick out the product template they need and drag it onto their workspace. They would generally continue grabbing the product templates of every shape, size and color and dragging it onto the workspace until they've finished designing their complete invitation suite.

As previously discussed, this graphics program (202) will often be a high-end, plug-in capable graphics program, such as Adobe Photoshop, Adobe Indesign, or Adobe Illustrator. Although other types of plug-in capable graphics programs may also be used, use of the Adobe family of graphics programs is often preferred because designers typically are both familiar and proficient with these programs. An additional advantage is that this family of programs has been written in a manner so that the various programs all use similar or identical applications programming interfaces (API) for their plug-ins, and all programs in this series may have similar user interfaces to create similar types of dialog windows and boxes to capture user input in a uniform manner. Thus a single type of plug-in, such as the invention's plug-in, may be developed and this plug-in in turn may operate on all three different graphics programs.

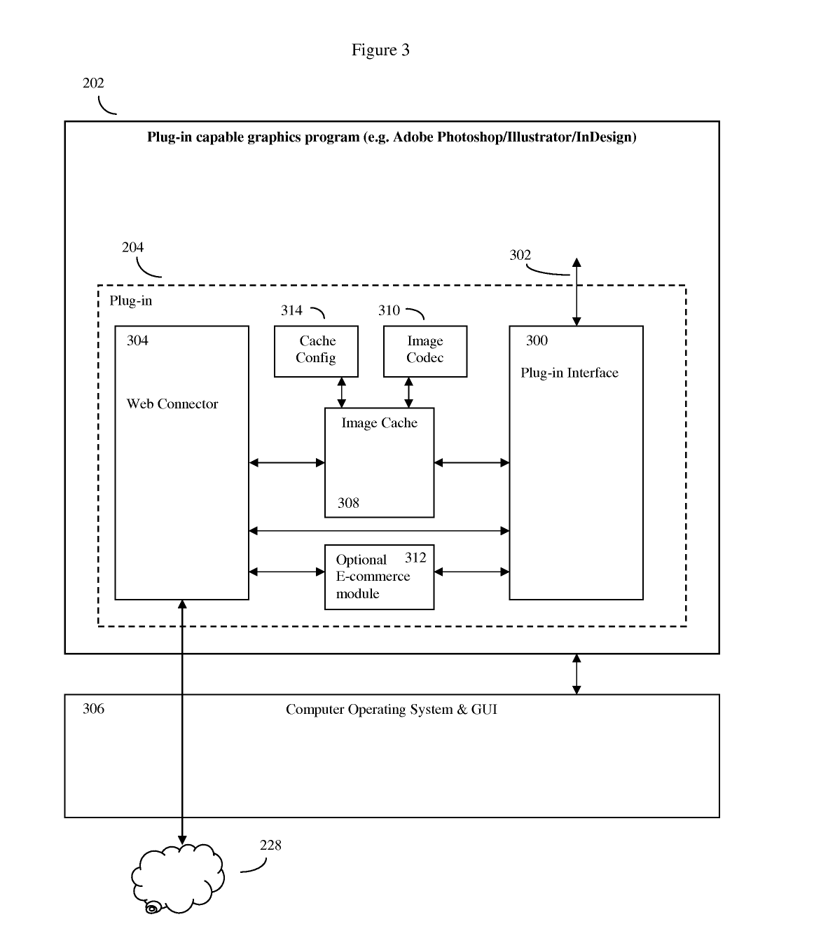

FIG. 3 shows a more detailed view of some of the major software modules of the invention's plug-in module (204) which will run under the control of the graphics program (202). In the particular embodiment discussed here, the plug-in was developed for 64 bit Windows using, as a development environment, MS Visual Studio.NET 2008 software, along with the Adobe Photoshop/Illustrator/InDesign Software Development Kit (SDK) for versions CS3/CS4/CS5; and WxWidgets 2.8.10 for interface development. For these purposes, WxWidgits is useful because it supports multi-platform (e.g. Windows/Mac) operation.

Example of various plug-in API which may be used in some embodiments of the invention include the API listed according to the Adobe Photoshop 5.5 Actions Event Gide, Version 5.5, Release 1, Adobe corporation (August 1999), Chapter 3, Creating an Automation Plug-In. In a preferred embodiment, the plug-in may follow the Adobe Plug-In Component Architecture (PICA) programming model.

Note that plug-in module (204) is thus dependent upon the host graphics program (202) for functionality. That is, it will generally be incapable of operating independently of the stand-alone graphics program (202).

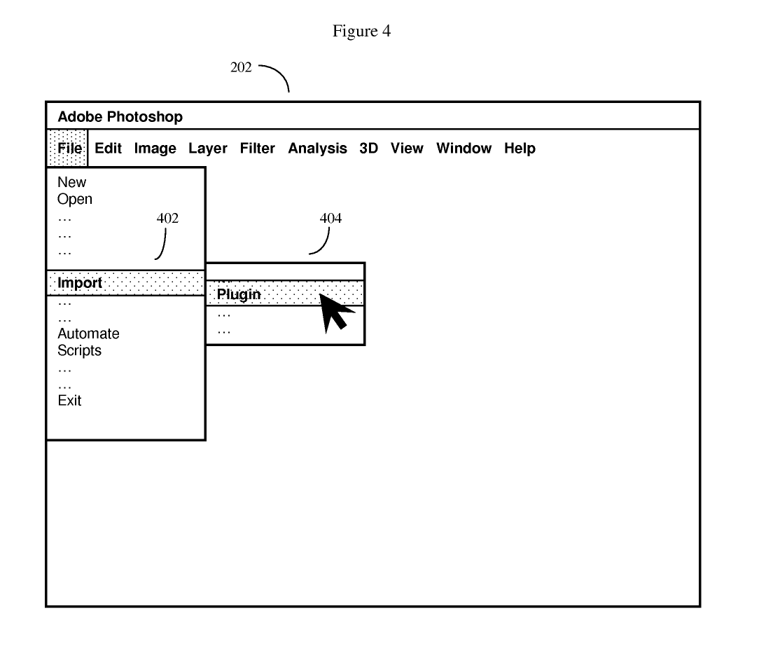

An example of the user interface for this plug-in is shown in FIGS. 4, 5 and 7. In one simple version, the interface may allow the user, while working within the graphics program (here Adobe Photoshop CS5 is used as an example) to simply go to a file import menu (400) and select the plug-in interface (402) to activate the plug-in.

Once activated, the plug-in will present the user with a remote server user interface (500), again running within the graphics program, and provide functionality to enable the system to access server (210) over the Internet (230). This interface may, for example, include a high level directory (502) of the various templates stored on server database (212), as well as more detailed directory information (504).

Returning to the plug-in description on FIG. 3, the plug-in may have an interface module (300) that communicates with the host graphics program (202) by suitable user interface API (302), and works with the graphics program to generate the various user interfaces shown in FIGS. 4, 5, and 7, such as (402), (502), (504), and so on.

The plug-in will also have a web connector module (304) that can accept commands from the plug-in interface (300) as well as from the remote server (210). This web connector module can work with the various API provided by the operating system (306) to enable communications (238) with server (210) over the Internet (228). The server can have a fixed or variable (i.e. user selectable) URL as desired.

Templates and other information retrieved from the server database (212) may be at least temporarily stored in the plug-in image cache (308). Other plug-in module components, such as various image codecs (310) may as needed read the template files and produce thumbnail images to show the user as desired. Alternatively, if the templates have their own thumbnail images attached as metadata, this codec module (310) may not be needed.

The plug-in module may also contain other software components, such as an optional e-commerce or user feedback module (312) and an optional cache configuration module (314) as needed.

The image cache module (308) may, for example provide the various image folders, image files, and their thumbnails requested by Plug-in Interface. This data in turn may be provided by Web connector (304) or may have been previously stored in the Image Cache (308).

Once a particular graphics program user data request (i.e. folder content view, image thumbnail view) is made, the Image Cache may first scan its own cache and if the requested data is present, the Image Cache will provide it to the graphics program. If the data is not present, the Image Cache will request the data from the Web connector (304), which in turn will bring it in from the server (210) and database (212). Once successfully retrieved, this data will then in turn be registered and stored in the Image Cache (308). If the data stored in cache (308) differs from the server's data (e.g. name and file size, updated date/time etc. are different), then the data in cache (308) will be corrected.

The Web Connector module (304) will support data communication with server (210) by standard protocols, often using standard HTTP protocols, since these tend to pass through various firewalls more easily. In addition to the basic template data such as name, folder and file list, the size of file, updated date etc.) and templates (e.g. the template image file), the data may also include various types of metadata, such as e-commerce metadata (e.g. price, purchasing information, in-stock information, user feedback, and the like).

Often, at least when the template data is stored separately from the template file itself, the various template files may be stored in the form of popular image formats, such as .png and other previously discussed formats, and here the image codec module (310) will support the coding and decoding functionality for these various formats.

Optional e-commerce module (312) may be used to provide an ecommerce interface allowing the user, while working within the user interface of the stand-alone graphics program (202), to order custom paper products corresponding to the templates for the various custom paper designs from the various manufacturers associated with these templates. E-commerce module may provide other useful functionality as well, such as a pricing calculator, and functionality to allow the user to mix-and match different templates from different manufactures and submit orders to these different manufacturers for a single job.

Here, the server (210) may also be configured to promote various e-commerce activities. In addition to providing a conduit between the various users and the various manufacturers (e.g. via paths (230) and (232) to (224) and (226), the server can be configured to perform additional functions such providing template metadata indicating the corresponding availability or in-stock status of their corresponding custom paper products. Users may also be allowed to register votes for new experimental templates or express interest in out-of-stock templates, which can give valuable information to the manufacturer as to unmet user needs.

Returning to FIG. 5, in this example, the user, working within Adobe Photoshop, has used the plug-in to read the contents of template database (212), and is viewing various thumbnail sketches of various templates produced by Manufacturer 2. In particular, the user is looking at the Manufacturer Duplex Black_linen line, and is particularly interested in retrieving the template associated with Invitation set 1 (506). To do this, the user has just clicked on the thumbnail image associated with the Invitation set 1 template. The plug-in interface (300) reads this click, and requests the template from remote server (210) and database (212) via the web connector (304), and retrieves the data into cache (308), where it may then be transferred to the main part of the graphics program (202).

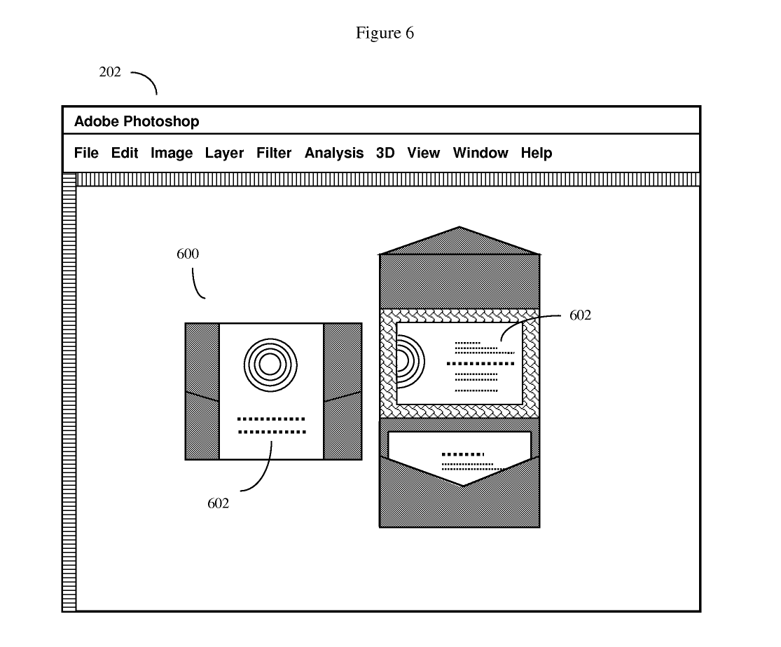

The results of this operation are shown in FIG. 6. The graphics program now contains a full-size version of the template (600). Using this template, the user can then change or alter text or graphics (602) on the template, add a background (e.g. (112)) as appropriate, and present a highly realistic version of the proposed invitation to the client. Often, in addition to containing color, texture, and paper dimensional size information, at least some templates will additionally contain recommended text font type, size, and layout data to facilitate adding such additional user supplied text and graphics.

Each product template may have several components to make the template complete. For example, the pocket invitation templates may be made available in open and closed as well as separate pieces. This way, a user can drag the closed, opened and front part of the pocket invitation template onto the workspace and put an insert in between the opened and front part to look like a complete pocket invitation with an invitation inside the pocket.

If the template is out of stock, or about to go out of stock, or alternatively is a new template uploaded by the manufacturer for product evaluation purposes, then the user may also use the plug-in interface to annotate the template with product request metadata, and transmit this back to the server. When this is done, then manufacturers (220), (222) can retrieve this annotation data over the Internet (224), (226) and upload price and availability information to the server, or alternatively transmit price and availability information to the user.

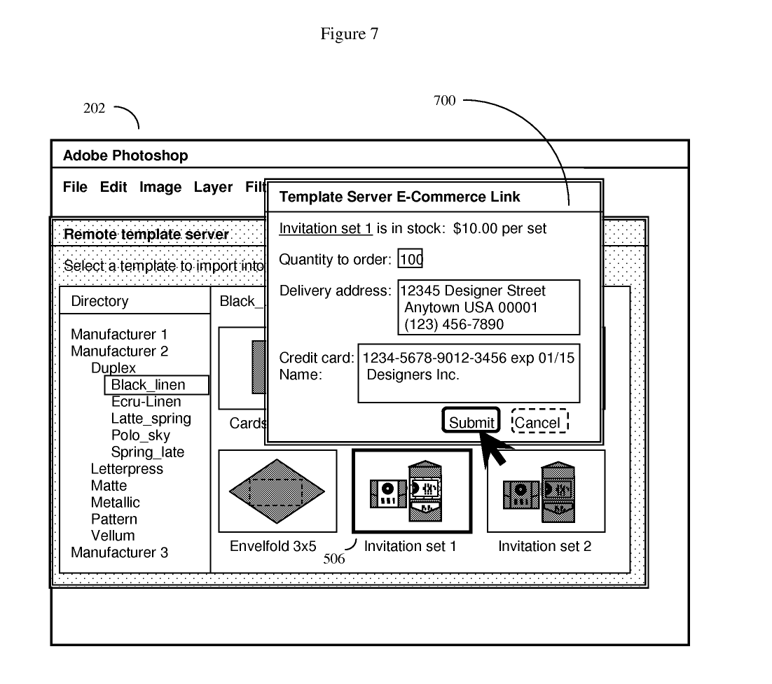

FIG. 7 shows an example of an additional e-commerce application, where the user can inquire about price and/or availability of a paper product or products that correspond to a particular template of interest, and either register interest in the template and/or order the corresponding paper product from the manufacturer or distributor.

Here the user may activate the e-commerce or user feedback user interface by any one of a variety of actions from within the graphics program (202), such as by right clicking a mouse when the user is focused on a template of interest, such as Invitation set 1 template (506). In this example, the plug-in interface module (300) can communicate (302) with the graphics program (202) to produce an e-commerce user interface (700). This interface can be loaded with basic price information and other relevant metadata. The user can then indicate various e-commerce functions such as quantity desired, delivery address, and method of payment. This data will then be communicated by the plug-in (204), interface (300) and the Web-connector module (304) back by the Internet (230) to server (210), which in turn can then transmit this data to the appropriate manufacturer (220), (222) by web connections such as (224), (226). Other data, such as user feedback and interest data can also be communicated by this same basic method.

1. A method of creating custom paper designs using a plug-in capable, stand-alone graphics program running on a local computerized device, said comprising;
storing a plurality of templates for custom paper designs on a remote Internet server, said templates being further annotated or linked to template metadata comprising at least said template identification data and template paper manufacturer identification data;
installing a plug-in for said graphics program, said plug-in allowing a user of said stand-alone graphics program, while working within the user interface of said stand-alone graphics program, to establish communication with said remote Internet server;
activating said plug-in from within said stand-alone graphics program, and retrieving template metadata from said remote Internet server;
viewing at least some of said metadata within said the user interface of said stand alone graphics program, and selecting at least one template based upon said template metadata;
importing said at least one selected template into said graphics program; and
using said imported template to create a custom paper design.

2. The method of claim 1, wherein said stand-alone graphics program is Adobe Photoshop, Adobe Indesign, or Adobe Illustrator, and said API are Adobe API, and wherein said plug-in operates in a cross-platform manner that that creates dialog windows and boxes that are portable across multiple graphics programs and platforms.

3. The method of claim 1, wherein said plug-in is incapable of operating independently of said stand-alone graphics program;
wherein said plug-in operates by interacting with the application programming interfaces (API) provided by said graphics program
wherein said plug-in generates a menu structure in said graphics program through API calls;
and wherein said plug-in receives at least some input from the user of said graphics program through program calls from said menu structure.

4. The method of claim 1, wherein said plug-in comprises an Internet connector module, an image cache module, and a plug-in interface module.

5. The method of claim 1, wherein said plug-in further provides an ecommerce interface allowing said user, while working within the user interface of said stand-alone graphics program, to order custom paper products corresponding to said templates for custom paper designs from one or more manufacturers associated with said templates.

6. The method of claim 5, wherein said plug-in further provides a pricing calculator.

7. The method of claim 5, wherein said plug-in allows the user to use templates provided by different manufacturers, and order custom paper products corresponding to said templates for custom paper designs from different manufacturers.

8. The method of claim 1, wherein said remote Internet server or said template metadata further arranges said templates according to the corresponding availability or in-stock status of the custom paper products corresponding to said templates.

9. The method of claim 1, further using said stand-alone graphics program to create a new template for a new custom paper design;
using said plug-in to annotate said new template with product request metadata;
using said plug-in to upload said new template and said product request metadata to said remote Internet server; and
wherein a manufacturer may download said new template and said product request metadata from said remote Internet server, and either upload price and availability information for said new template to said remote Internet server, and/or transmit said transmit price and availability information for said new template to said user.

10. The method of claim 1, wherein said template additionally contains recommended text layout and text font information.

11. The method of claim 1, wherein said users may change the colors or textures of said templates.

12. The method of claim 1, further providing a manufacturer interface to said remote Internet server wherein different manufacturers may upload templates to said remote Internet server.

13. The method of claim 1, wherein a plurality of users may register interests or votes on a template or proposed new template.

14. A method of creating custom paper designs using a plug-in capable, stand-alone graphics program running on a local computerized device, said comprising;
storing a plurality of templates for custom paper designs on a remote Internet n server, said templates being further annotated or linked to template metadata comprising at least said template identification data and template paper manufacturer identification data;
further providing a manufacturer interface to said remote Internet server wherein different manufacturers may upload templates to said remote Internet server;
installing a plug-in for said graphics program, said plug-in allowing a user of said stand-alone graphics program, while working within the user interface of said stand-alone graphics program, to establish communication with said remote Internet server;
wherein said plug-in is incapable of operating independently of said stand-alone graphics program;
wherein said plug-in operates by interacting with the application programming interfaces (API) provided by said graphics program;
wherein said plug-in generates a menu structure in said graphics program through API calls;
and wherein said plug-in receives at least some input from the user of said graphics program through program calls from said menu structure;
wherein said plug-in comprises an Internet connector module, an image cache module, and a plug-in interface module;
activating said plug-in from within said stand-alone graphics program, and retrieving template metadata from said remote Internet server;
viewing at least some of said metadata within said the user interface of said stand alone graphics program, and selecting at least one template based upon said template metadata;
importing said at least one selected template into said graphics program; and
using said imported template to create a custom paper design.

15. The method of claim 14, wherein said stand-alone graphics program is Adobe Photoshop, Adobe Indesign, or Adobe Illustrator, and said API are Adobe API, and wherein said plug-in operates in a cross-platform manner that that creates dialog windows and boxes that are portable across multiple graphics programs and platforms.

16. The method of claim 14, wherein said plug-in further provides an ecommerce interface allowing said user, while working within the user interface of said stand-alone graphics program, to order custom paper products corresponding to said templates for custom paper designs from one or more manufacturers associated with said templates;
wherein said plug-in further provides a pricing calculator; and
wherein said plug-in allows the user to use templates provided by different manufacturers, and order custom paper products corresponding to said templates for custom paper designs from different manufacturers.

17. The method of claim 14, wherein said template additionally contains recommended text layout and text font information; and
wherein said users may change the colors or textures of said templates.

18. The method of claim 14, further using said stand-alone graphics program to create a new template for a new custom paper design;
using said plug-in to annotate said new template with product request metadata;
using said plug-in to upload said new template and said product request metadata to said remote Internet server;
wherein a plurality of users may register interests or votes said new template; and
wherein a manufacturer may download said new template and said product request metadata from said remote Internet server, and either upload price and availability information for said new template to said remote Internet server, and/or transmit said transmit price and availability information for said new template to said users.

19. A method of creating custom paper designs using a plug-in capable, stand-alone graphics program running on a local computerized device, said comprising;
storing a plurality of templates for custom paper designs on a remote Internet server, said templates being further annotated or linked to template metadata comprising at least said template identification data and template paper manufacturer identification data;
further providing a manufacturer interface to said remote Internet server wherein different manufacturers may upload templates to said server;
installing a plug-in for said graphics program, said plug-in allowing a user of said stand-alone graphics program, while working within the user interface of said stand-alone graphics program, to establish communication with said remote Internet server;
wherein said stand-alone graphics program is Adobe Photoshop, Adobe Indesign, or Adobe Illustrator, and said API are Adobe API, and wherein said plug-in operates in a cross-platform manner that that creates dialog windows and boxes that are portable across multiple graphics programs and platforms;
wherein said plug-in is incapable of operating independently of said stand-alone graphics program;
wherein said plug-in operates by interacting with the application programming interfaces (API) provided by said graphics program;
wherein said plug-in generates a menu structure in said graphics program through API calls;
and wherein said plug-in receives at least some input from the user of said graphics program through program calls from said menu structure;
wherein said plug-in comprises an Internet connector module, an image cache module, and a plug-in interface module;
activating said plug-in from within said stand-alone graphics program, and retrieving template metadata from said remote Internet server;
viewing at least some of said metadata within said the user interface of said stand alone graphics program, and selecting at least one template based upon said template metadata;
importing said at least one selected template into said graphics program; and
using said imported template to create a custom paper design;
wherein said plug-in further provides an ecommerce interface allowing said user, while working within the user interface of said stand-alone graphics program, to order custom paper products corresponding to said templates for custom paper designs from one or more manufacturers associated with said templates; and
wherein said plug-in allows the user to use templates provided by different manufacturers, and order custom paper products corresponding to said templates for custom paper designs from different manufacturers.

20. The method of claim 19, further using said stand-alone graphics program to create a new template for a new custom paper design;
using said plug-in to annotate said new template with product request metadata;
using said plug-in to upload said new template and said product request metadata to said remote Internet server;
wherein a plurality of users may register interests or votes said new template; and
wherein a manufacturer may download said new template and said product request metadata from said remote Internet server, and either upload price and availability information for said new template to said remote Internet server, and/or transmit said transmit price and availability information for said new template to said users.
